(19) United States
(12) Patent Application Publication
(10) Pub. No.: US 2006/0036192 A1
(43) Pub. Date: Feb. 16, 2006

(54) Ultrasonic system for treatment of urologic diseases and ultrasonic instrument for these purposes and ultrasonic urologic set

(76) Inventors: Oleg Stepanovich Naraikin, Moscow (RU); Gennady Victorovich Savrasov, Moscow (RU)

Correspondence Address: KNOBBE MARTENS OLSON & BEAR LLP, 2040 MAIN STREET, FOURTEENTH FLOOR, IRVINE, CA, 92614, US

(21) Appl. No.: 11/151,725

(22) Filed: Jun. 13, 2005

Related U.S. Application Data
(63) Continuation-in-part of application No. 10/169,522, filed on Jul. 2, 2002, now Pat. No. 6,905,473.

(30) Foreign Application Priority Data
Jan. 17, 2002 (WO) 02/04074
Jul. 10, 2000 (RU) 2000118669

(51) Int. Cl. A61H 1/00

(52) U.S. Cl. 601/2

(57) ABSTRACT

An ultra sonic system is for treatment of urologic diseases. The system includes an ultrasonic generator providing the working field in the frequency range of 15 to 100 kHz and amplitude 2 to 180 mcm, an acoustic unit coupled to the generator and an ultrasonic instrument that connects rigidly with the acoustic unit. The ultrasonic instrument is a multi half-wave concentrator wave-guide, including a core with changeable cross-section and a working end. A length of the working end is to a length of the core as 3/100 to 3/40. The largest size of cross-section of the core in a place of connection with the working end is to the largest size of cross-section of the working end, as 1/20 to 6/1.

### RELATED APPLICATION

This application is a continuation-in-part application of U.S. patent application Ser. No. 10/169,522, filed on Jul. 2, 2002.

### BACKROUND OF THE INVENTION

1. Field of the Invention

The present invention relates generally to medical devices and is concerned with ultrasonic means to act to biological tissue. More particularly, the present invention relates to ultrasonic system for treatment of urologic diseases.

2. Description of the Prior Art

Ultrasound is widely applied in the modern medicine to diagnose various diseases, in therapy and surgical practice. We use ultrasound to sterilize liquids, surgical tools, prepare medicinal substances. Ultrasonic therapy is useful for treatment and preventive maintenance of treatment of a person. Various thermal and physical and chemical factors causing anti-inflammatory, anesthetizing and stimulating reactions in processable tissues are a base of therapeutic action of a ultrasonic field.

The ultrasonic surgery is based on mechanical action to biological tissues by means of mid-frequency and low-frequency ultrasonic vibrations.

Now there are a lot of ultrasonic devices providing various methods of action to biological tissues and are intended for different purposes.

Ultrasonic method and apparatus for cosmetic and dermatological applications are taught in the U.S. Pat. No. 5,618,275, issued Apr. 8, 1997, to Robert Bock. Low frequency ultrasonic pressure waves are applied to the skin of sufficiently high intensity to cause cavitation in the skin which facilitates penetration of a therapeutic agent such as medicine or a cosmetic such as moisturizer. The therapeutic agent may be applied to the skin to the application of the pressure waves. The therapeutic agent may also be applied to the skin subsequent to the application of the pressure waves.

Apparatus and methods for ultrasonically enhanced fluid delivery are taught in the U.S. Pat. No. 5,735,811, issued Apr. 7, 1998, to Axel Bricken. The apparatus for the ultrasonically enhanced localized delivery of therapeutic fluids, for example fibrinolytic and anti-thrombogenic agents, within the vasculature and other body lumens has been proposed.

Transdermal delivery of encapsulated drugs is taught in the U.S. Pat. No. 5,814,599, issued Sep. 29, 1998, to Samir Mitragotri. Applications of low-frequency ultrasound enhances transdermal transport of high-molecular weight proteins, for example insulin or gamma interferon. This method includes a simultaneous application of ultrasound and protein on the skin surface in order to deliver therapeutic doses of proteins across the skin.

Method and apparatus for selective cell destruction are taught in the U.S. Pat. No. 4,315,514, issued Feb. 16, 1982, to William Drewes. The use of ultrasound for destroying selected cells in a host without damage to non-selected cells is disclosed. In order to select a suitable resonant frequency for use in destroying the abnormal cells, the various resonant frequencies and corresponding damping coefficients of the abnormal cells must be determined. To do so, a biopsy of the abnormal cells is preferably taken.

Apparatus for transport of fluids across, into or from biological tissues are taught in the U.S. Pat. No. 6,096,000, issued Aug. 1, 2000, to Katsuro Tachibana. An apparatus for creating holes in a biological tissue is disclosed. The apparatus includes a housing which at least partially defines a fluid chamber. The fluid chamber including a tissue contact surface which is configured to be positioned adjacent the biological tissue. An ultrasound delivery device is positioned adjacent the fluid chamber and is configured to cavitate a fluid within the fluid chamber. A plurality of apertures extend from the fluid chamber through the tissue contact surface. The apertures are sized to permit passage of the cavitated fluid through the apertures.

None of the before-mentioned patents or prior arts is intended and may be used for purposes of the present invention.

Inventors proposed systems that realize the ultrasonic technologies of the contact and hydrodynamic action to biological tissues for treatment of urologic diseases.

The system for ultrasonic action on blood vessel or cavernous body is diclosed in the RU. Pat. No 2,214,193, issued Oct. 10, 2003, to Savrasov. The ultrasonic instrument has a concentrator waveguide with a pointed end, by which a puncture of the wall of the vessel or cavernous body is accomplished, and a working part, which is introduced through this puncture inside the vessel or cavernous body thus realizing the method of ultrasonic action. Provided action on the inner cavity of the vessel or cavernous body reduces loss of blood, reduces traumatism of tissues, eliminates necessity of use of devices cutting out the vessel from the blood flow.

This system is used in vascular surgery of an internal cavity of a vessel and hemorrhoids and is not intended for the treatment of such urologic diseases, as acute and chronic prostatitis, different stages of adenoma of prostate and also for surgery in organs of the urogenital system.

Until now treatment of diseases of urogenital system is an actual urologic problem. It is due to a prevalence of diseases of urogenital system, and also known methods and means of medicamentous therapy are insufficiently effective and often do not meet doctor's requirements because of a various sort of complications, relapses of disease, and also long terms of treatment of patients.

The method and device for action with a ultrasonic field to biological tissue, comprising a ultrasonic generator for transformation of the electric energy to ultrasonic energy, a acoustic unit for transformation of electric vibrations in mechanical, their amplification and further transfer, and a ultrasonic instrument that is a concentrator wave guide in the form of a core with working end are disclosed in U.S. application Ser. No. 10/169,522 to the same inventors. The notification of grant of Patent of method of ultrasonic action to biological tissues was received under this application.

### BRIEF SUMMARY OF THE INVENTION

The present invention is the further improvement of the device taught in the patent U.S. application Ser. No. 10/169,522 to the same inventors, dicloses a particular case of the general device applicable in urology and is intended for treatment of patients with urologic diseases.

The invention provides such ultrasonic system for treatment urologic diseases, ultrasonic instrument for these purposes and ultrasonic urologic set that allow to realize all necessary complex of ultrasonic actions to reduce terms of treatment in 1.5-2 times at simultaneous reduction of number of relapses, and also to enhance convenience in service.

The ultrasonic system for treatment of urologic diseases is provided, the system comprising:
an ultrasonic generator providing the working field in the frequency range of 15 to 100 kHz and amplitude 2 to 180 mcm; an acoustic unit coupled to the generator, and an ultrasonic instrument that connects rigidly with the acoustic unit, wherein the ultrasonic instrument is a multi half-wave concentrator wave-guide, including a core with changeable cross-section and a working end, and a length of the working end is to a length of the core as 3/100 to 3/40; and the largest size of cross-section of the core in a place of connection with the working end is to the largest size of cross-section of the working end, as 1/20 to 6/1.

The working end of the concentrator wave-guide is a body of revolution, and the largest size of cross-section of the core in a place of connection with the body of revolution is to the largest size of cross-section of the last one, as 1/2 to 1/20 or the working end of the concentrator wave-guide is a body of revolution, and the largest size of cross-section of the core in a place of connection with the body of revolution is to the largest size of cross-section of the last one, as 4/1 to 1/1 or the working end of the concentrator wave-guide is a two-dimensional, thin-walled element, wherein the largest size of cross-section of the core in a place of connection with the element is to the largest size of cross-section of the last one, as 1/5 to 1/1 or the working end of the concentrator wave-guide is a two-dimensional, thin-walled element, wherein the largest size of cross-section of the core in a place of connection with the element is to the largest size of cross-section of the last one, as 1/20 to 1/1.

An ultrasonic instrument is provided, wherein the ultrasonic instrument is a multi half-wave concentrator wave-guide, including a core with changeable cross-section and a working end, wherein the working end of the concentrator wave-guide is a body of revolution, and the largest size of cross-section of the core in a place of connection with the body of revolution is to the largest size of cross-section of the last one, as 1/2 to 1/20 or 4/1 to 1/1.

An ultrasonic instrument, wherein the ultrasonic instrument is a multi half-wave concentrator wave-guide is provided, including a core with changeable cross-section and a working end, wherein the working end of the concentrator wave-guide is a two-dimensional, thin-walled element, and the largest size of cross-section of the core in a place of connection with the element is to the largest size of cross-section of the last one, as 1/5 to 1/1 or 1/20 to 1/1.

Optimal embodiment of this invention, realized in the practice, is a ultrasonic set for treatment of urologic diseases comprising a ultrasonic generator, an acoustic unit, units for feeding and evacuation of liquid phase and replaceable ultrasonic instruments, each of the instruments is a multihalf-wave concentrator wave-guide including a core with a working end wherein the working end is in form of olive, sphere, convex semi-sphere, concave semi-sphere, cylinder, cylinder with a bevelled butt end, cylinder with a convex butt end, scalpel, loop with cutting edge.

### BRIEF DESCRIPTION OF THE SEVERAL VIEWS OF THE DRAWINGS

Several features of the present invention are further described in connection with the accompanying drawings, in which

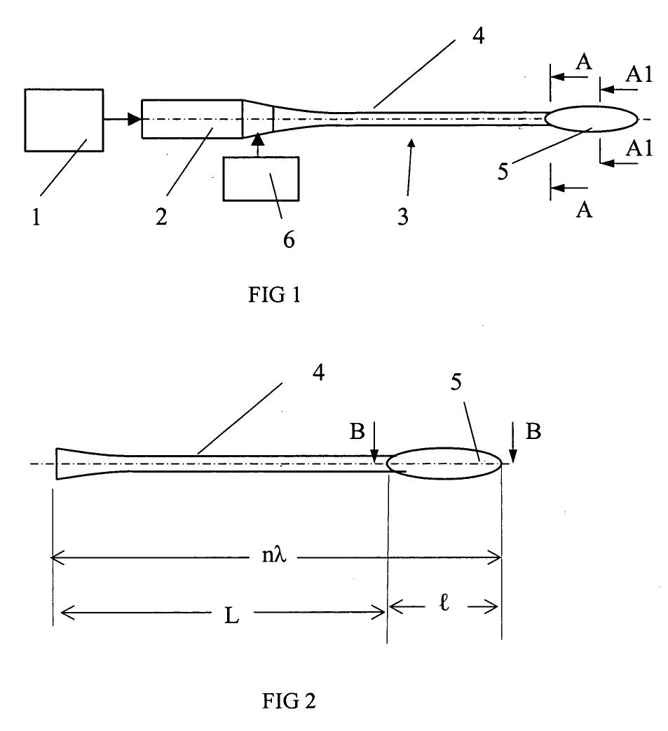

There is illustrated in FIG. 1 a general view of the ultrasonic system for treatment of urologic diseases;

There is illustrated in FIG. 2 a general view of the ultrasonic instrument for these purposes;

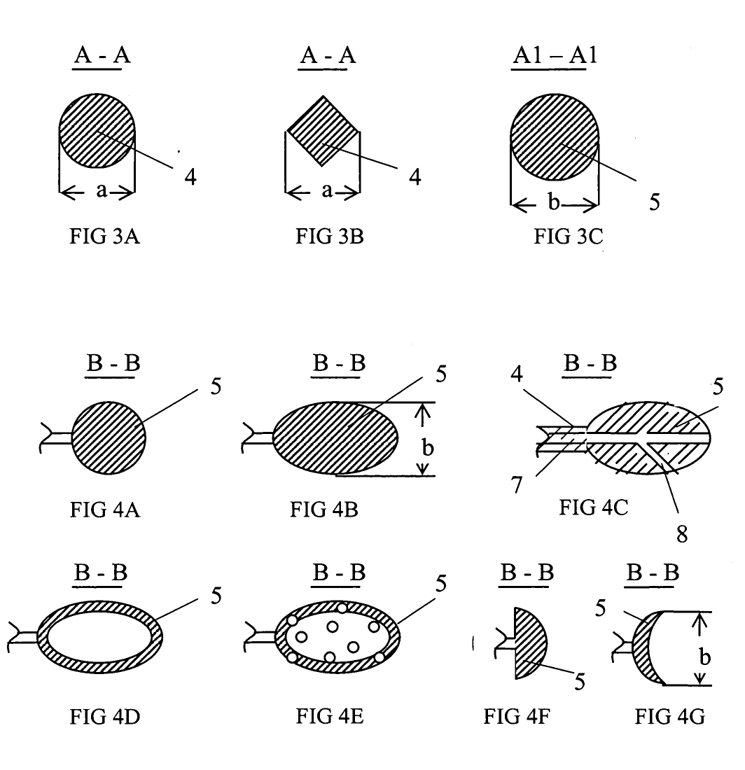

There are illustrated in FIGS. 3 A-3 C some of variants of cross-section of the core in a place of connection with the working end; and

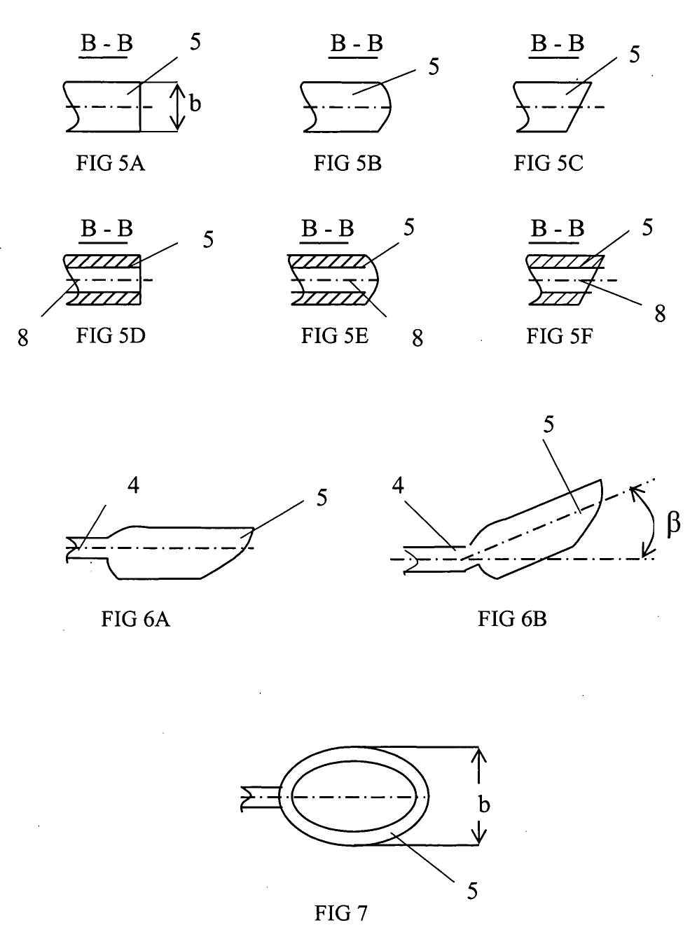

There are illustrated in FIGS. 4 A-4G and FIGS. 5 A-5F preferable variants of the working end of the ultrasonic instrument in the form of bodies of revolution and their cross-sections;

There are illustrated in FIGS. 6A-6B and FIG. 7 preferable variants of the working end of the ultrasonic instrument in the form of two-dimensional, thin-walled elements and their cross-sections.

### DETAILED DESCRIPTION OF THE INVENTION

The ultrasonic system for treatment of urologic diseases, showing in FIG. 1, comprises an ultrasonic generator 1 providing the working field in the frequency range of 15 to 100 kHz and amplitude 2 to 180 mcm, an acoustic unit 2 coupled to the generator, and an ultrasonic instrument 3 that connects rigidly with the acoustic unit, wherein the ultrasonic instrument is a multi half-wave concentrator wave-guide, including a core 4 with changeable cross-section and a working end 5. The system can be provided with the feed unit of liquid phase into the working end 5.

The numerous experimental researches realized by the applicant have shown, that the best effect of ultrasonic action for treatment of gynecologic diseases is reached when a length l of the working end 5 is to a length L of the core 4 as 3/100 to 3/40; and the largest size of cross-section—a of the core 4 in a place of connection with the working end 5 is to the largest size of cross-section—b of the working end 5, as 1/20 to 6/1.

Performance of the ultrasonic instrument 3 with other proportion of the sizes does not allow to realize effective ultrasonic action to biological tissues, and also, do not provide compatibility of ergonomic and technological parameters of this action.

Also it is important, that the length of the core of the concentrator wave-guide is one, two, three or more half-wave of the ultrasonic vibrations to provide delivery of necessary energy of ultrasonic vibrations in a zone of action.

One of embodiments of a system for treatment of urologic diseases is a variant when the working end 5 of the concentrator wave-guide 3 is a body of revolution, and the largest size of cross-section of the core—a in a place of connection with the body of revolution is to the largest size of cross-section—b of the last one, as 1/2 to 1/30.

Thus, longitudinal section B-B of the working end of the ultrasonic instrument 3 can represent a circle, as shown in FIG. 4A or an oval, as shown in FIG. 4B.

Other embodiment of a system for treatment of urologic diseases is a variant when the working end 5 of the concentrator wave-guide 3 is a body of revolution, and the largest size of cross-section of the core—a in a place of connection with the body of revolution is to the largest size of cross-section—b of the last one, as 4/1 to 1/1.

Thus, longitudinal section of the working end of the ultrasonic instrument 3 can represent a square, as shown in FIG. 5D.

One more embodiment of a system for treatment of urologic diseases is a variant when the working end 5 of the concentrator wave-guide 3 is a two-dimensional, thin-walled element, as shown in FIGS. 6A-6B wherein the largest size of cross-section of the core 4—a in a place of connection with the element is to the largest size of cross-section—b of the last one, as 1/5 to 1/1.

Thus, the two-dimensional, thin-walled element can be plane, as shown in FIG. 6A, or curved in a vertical plane, as shown in FIG. 6B.

The following embodiment of a system for treatment of gynecologic diseases is a variant when the working end 5 of the concentrator wave-guide 3 is a two-dimensional, thin-walled element, as shown in FIGS. 8A-8B, wherein the largest size of cross-section of the core 4—a in a place of connection with the element is to the largest size of cross-section—b of the last one, as 1/20 to 1/1.

The ultrasonic instrument 3 in proposed system can revolve or make longitudinal movement by means drive (it is not shown in Fig)

The working end 5 of the ultrasonic instrument 3 can set to an angle β 30 to 45 degrees to an axis of the last one, as it is shown on FIG. 6C.

The proposed system can be provided of feed unit of liquid phase 6 in a chamber of the working end through the ducts for pass of a liquid phase 7 in a core 4 of ultrasonic instrument 3, and further in ducts 8 as it is shown on FIG. 4C.

Thus, it is preferable to provide the feed unit of liquid phase 6 in the form of a injector. (in drawings it is not shown)

Inventors propose also the ultrasonic instrument that is a multi half-wave concentrator wave-guide, including a core 4 with changeable cross-section and a working end 5, and a length of the working end is to a length of the core as 3/100 to 3/40; wherein the working end of the concentrator wave-guide is a body of revolution, and the largest size of cross-section of the core 4—a (FIGS. 3A, 3B) in a place of connection with the body of revolution is to the largest size of cross-section (FIG. 3C) of the last one, as 1/2 to 1/20.

The working end 5 can be solid (FIGS. 4A and 4B), with ducts for movement of liquid phase (FIG. 4C), hollow (FIG. 4D) and perforated (FIG. 4E), convex semi-sphere, concave semi-sphere (FIGS. 4F, 4G). The working end 5 can have the form of a sphere (FIG. 4A) and olive (FIG. 4B).

One more embodiment of the ultrasonic instrument is the following the ultrasonic instrument that is a multi half-wave concentrator wave-guide, including a core 4 with changeable cross-section and a working end 5, and a length of the working end is to a length of the core as 3/100 to 3/40; wherein the working end of the concentrator wave-guide is a body of revolution, and the largest size of cross-section of the core 4—a (FIGS. 3A, 3B) in a place of connection with the body of revolution is to the largest size of cross-section (FIG. 3C) of the last one, as 4/1 to 1/1.

The working end 5 can be solid (FIGS. 5A and 5B, 5C), with ducts for movement of liquid phase (FIG. 5E, 5F), hollow and perforated.

The working end 5 can have the form of a cylinder (FIGS. 5A, 5E), cylinder with a bevelled butt end (FIG. 5C), cylinder with a convex butt end (FIG. 5C).

One more embodiment is the ultrasonic instrument that is a multi half-wave concentrator wave-guide, including a core 4 with changeable cross-section and a working end, and a length of the working end 5 is to a length of the core as 3/100 to 3/40; wherein the working end of the concentrator wave-guide is a two-dimensional, thin-walled element, and the largest size of cross-section of the core 4—a (FIGS. 3A, 3B) in a place of connection with the element is to the largest size of cross-section (FIG. 3C) of the last one, as 1/5 to 1/1.

The working end 5 can have the form of a scalpel (FIGS. 6A, 6B).

One more embodiment is the ultrasonic instrument that is a multi half-wave concentrator wave-guide, including a core 4 with changeable cross-section and a working end, and a length of the working end 5 is to a length of the core as 3/100 to 3/40; wherein the working end of the concentrator wave-guide is a two-dimensional, thin-walled element, and the largest size of cross-section of the core 4—a (FIGS. 3A, 3B) in a place of connection with the element is to the largest size of cross-section (FIG. 3C) of the last one, as 1/20 to 1/1.

The working end 5 can have the form of loop with internal cutting edge (FIG. 7). The optimal embodiment of the system for treatment of urologic diseases is a ultrasonic set for treatment of urologic diseases comprising a ultrasonic generator 1, an acoustic unit 2, units for feeding and evacuation of liquid phase 6 and replaceable ultrasonic instruments 3, each of the instruments is a multihalf-wave concentrator wave-guide including a core 4 with a working end 5 wherein the working end is in form of of olive, sphere, convex semi-sphere, concave semi-sphere, cylinder, cylinder with a bevelled butt end, cylinder with a convex butt end, scalpel, spade, loop with cutting edge.

What is claimed is:

1. A ultrasonic system for treatment of urologic diseases, the system comprising:
an ultrasonic generator providing the working field in the frequency range of 15 to 100 kHz and amplitude 2 to 180 mcm;
an acoustic unit coupled to the generator, and
an ultrasonic instrument that connects rigidly with the acoustic unit, wherein
the ultrasonic instrument is a multi half-wave concentrator wave-guide, including a core with changeable cross-section and a working end,
and a length of the working end is to a length of the core as 3/100 to 3/40;
and the largest size of cross-section of the core in a place of connection with the working end is to the largest size of cross-section of the working end, as 1/20 to 6/1.

2. The system according to claim 1 wherein the length of the core of the concentrator wave-guide is one, two, three or more half-wave of the ultrasonic vibrations.

3. The system according to claim 1 wherein the working end of the concentrator wave-guide is a body of revolution, and the largest size of cross-section of the core in a place of connection with the body of revolution is to the largest size of cross-section of the last one, as 1/2 to 1/20.

4. The system according to claim 3 wherein the longitudinal section of the working end of the concentrator wave-guide is a circle or a oval.

5. The system according to claim 1 wherein the working end of the concentrator wave-guide is a body of revolution, and the largest size of cross-section of the core in a place of connection with the body of revolution is to the largest size of cross-section of the last one, as 4/ to 1/1.

6. The system according to claim 5 wherein the longitudinal section of the working end of the concentrator wave-guide is a square.

7. The system according to claim 1 wherein the working end of the concentrator wave-guide is a two-dimensional, thin-walled element, wherein the largest size of cross-section of the core in a place of connection with the element is to the largest size of cross-section of the last one, as 1/5 to 1/1.

8. The system according to claim 7 wherein the two-dimensional, thin-walled element is plane.

9. The system according to claim 7 wherein the two-dimensional, thin-walled element is curved in vertical plane.

10. The system according to claim 1 wherein the working end of the concentrator wave-guide is a two-dimensional, thin-walled element, wherein the largest size of cross-section of the core in a place of connection with the element is to the largest size of cross-section of the last one, as 1/20 to 1/1.

11. The system according to claim 10 wherein the two-dimensional, thin-walled element is plane with an aperture.

12. The system according to claim 1 wherein the ultrasonic instrument can revolve.

13. The system according to claim 1 wherein the ultrasonic instrument can make longitudinal movement.

14. The system according to claim 1 wherein the working end of the concentrator wave-guide is set to an angle 30 to 45 degrees to an axis of the concentrator wave-guide.

15. The system according to claim 1 wherein the system is provided with a feed unit of liquid phase into the ducts of the working end and the core of the concentrator wave-guide has a duct for motion of liquid phase.

16. The system according to claim 15 wherein the feed unit of liquid phase is a injector.

17. An ultrasonic instrument, wherein
the ultrasonic instrument is a multi half-wave concentrator wave-guide, including a core with changeable cross-section and a working end,
and a length of the working end is to a length of the core as 3/100 to 3/40;
wherein the working end of the concentrator wave-guide is a body of revolution,
and the largest size of cross-section of the core in a place of connection with the body of revolution is to the largest size of cross-section of the last one, as 1/2 to 1/20.

18. The ultrasonic instrument according claim 17 wherein the working end of the concentrator wave-guide is solid.

19. The ultrasonic instrument according claim 18 wherein the core of the concentrator wave-guide has a duct for movement of liquid phase.

20. The ultrasonic instrument according claim 17 wherein the working end of the concentrator wave-guide is hollow.

21. The ultrasonic instrument according claim 20 wherein the working end of the concentrator wave-guide is perforated.

22. The ultrasonic instrument according claim 18 wherein the working end of the concentrator wave-guide is in form of a sphere.

23. The ultrasonic instrument according claim 18 wherein the working end of the concentrator wave-guide is in form of a olive.

24. An ultrasonic instrument, wherein
the ultrasonic instrument is a multi half-wave concentrator wave-guide, including a core with changeable cross-section and a working end,
and a length of the working end is to a length of the core as 3/100 to 3/40;
wherein the working end of the concentrator wave-guide is a body of revolution,
and the largest size of cross-section of the core in a place of connection with the body of revolution is to the largest size of cross-section of the last one, as 4/1 to 1/1.

25. The ultrasonic instrument according claim 24 wherein the working end of the concentrator wave-guide is solid.

26. The ultrasonic instrument according claim 25 wherein the core of the concentrator wave-guide has a duct for movement of liquid phase.

27. The ultrasonic instrument according claim 24 wherein the working end of the concentrator wave-guide is hollow.

28. The ultrasonic instrument according claim 27 wherein the working end of the concentrator wave-guide is perforated.

29. The ultrasonic instrument according claim 24 wherein the working end of the concentrator wave-guide is in form of a cylinder.

30. The ultrasonic instrument according claim 29 wherein the working end of the concentrator wave-guide is in form of a cylinder with a bevelled butt end.

31. The ultrasonic instrument according claim 29 wherein the working end of the concentrator wave-guide is in form of a cylinder with a convex butt end.

32. An ultrasonic instrument, wherein
the ultrasonic instrument is a multi half-wave concentrator wave-guide, including a core with changeable cross-section and a working end,
and a length of the working end is to a length of the core as 3/100 to 3/40;
wherein the working end of the concentrator wave-guide is a two-dimensional, thin-walled element,
and the largest size of cross-section of the core in a place of connection with the element is to the largest size of cross-section of the last one, as 1/5 to 1/1.

33. The ultrasonic instrument according claim 32 wherein the working end of the concentrator wave-guide is in form of a scalpel.

34. An ultrasonic instrument, wherein
the ultrasonic instrument is a multi half-wave concentrator wave-guide, including a core with changeable cross-section and a working end,
and a length of the working end is to a length of the core as 3/100 to 3/40;
wherein the working end of the concentrator wave-guide is a two-dimensional, thin-walled element,
and the largest size of cross-section of the core in a place of connection with the element is to the largest size of cross-section of the last one, as 1/20 to 1/1.

35. The ultrasonic instrument according claim 34 wherein the working end of the concentrator wave-guide is in form of a loop with internal cutting edge.

36. A ultrasonic set for treatment of urologic diseases comprising a ultrasonic generator, an acoustic unit, units for feeding and evacuation of liquid phase and replaceable ultrasonic instruments, each of the instruments is a multihalf-wave concentrator wave-guide including a core with a working end wherein the working end is in form of olive, sphere, convex semi-sphere, concave semi-sphere, cylinder, cylinder with a bevelled butt end, cylinder with a convex butt end, scalpel, loop with cutting edge.
